(19) United States
(12) Patent Application Publication
(10) Pub. No.: US 2026/0299617 A1
(43) Pub. Date: Oct. 1, 2026

(54) WIRED DRONE FOR TREATING A SURFACE BY SPRAYING A TREATMENT FLUID

(71) Applicant: FLY RENOV, LEVALLOIS-PERRET (FR)

(72) Inventors: Anil NARASSIGUIN, LEVALLOIS-PERRET (FR); Pierre VIDAL, LEVALLOIS-PERRET (FR)

(73) Assignee: FLY RENOV, LEVALLOIS-PERRET (FR)

(21) Appl. No.: 19/490,849

(22) PCT Filed: Jun. 7, 2024
(86) PCT No.: PCT/EP2024/065810

§ 371 Date: Jan. 23, 2026

(30) Foreign Application Priority Data
Jun. 8, 2023 (FR) FR2305773

(51) Int. Cl. G05D 1/689; B64D 1/18; G01S 15/08; G01S 15/89; G05D 1/242; G05D 1/246; G05D 105/10; G05D 107/90; G05D 109/20; G05D 111/20

(52) U.S. Cl. CPC G05D 1/689; B64D 1/18; G01S 15/08; G01S 15/89; G05D 1/242; G05D 1/246; G05D 2105/10; G05D 2107/90; G05D 2109/20; G05D 2111/20

(57) ABSTRACT

The invention relates to a wired drone (100) for treating a surface (200), comprising:—a propulsion system, and —a fluid spraying system. The drone is essentially characterised in that it comprises:—a first sonar (110),—a second sonar (120), and —an arithmetic unit configured to: determine the distance between each sonar and the surface (200); calculate the difference between the measurement of the first sonar (110) and of the second sonar (120); and deduce therefrom:—the yaw angle of the drone (100), and —the distance of the drone (100) from the surface (200); and control the position of the drone (100) by the difference between:—the calculated distance and a predetermined distance setpoint, and—the calculated yaw angle of the drone (100) and a predetermined yaw angle setpoint of the drone (100).

The present invention relates to surface treatment in the field of construction, maintenance, cleaning and renovation. The surface to be treated may be of any type, regardless of its covering, such as a frontage or roof of buildings, whether they are residential (detached house, apartment block) or commercial (offices, factories, silos, etc.), or more generally any plane or non-plane surface which has a height of more than 2 m, for example a wind turbine, including both its tower and its blades.

In this field, it is often necessary to perform dangerous tasks, such as working at height or on materials or substances which are hazardous, for example carcinogenic, mutagenic and reprotoxic (CMR).

In particular, the dangerous tasks consist in projecting fluids, liquids or gases onto surfaces of buildings.

The document FR3048415 is known. However, the device which it presents requires a telescoping mast and a camera on the latter, which is impractical. The document WO2020021305 is also known, but it requires supporting means to keep a drone in contact with the surface to be treated.

The Applicant has also filed the application FR3125017 in this field.

In this field, the Applicant has observed that the mist generated by spraying a fluid interferes with the distance sensors.

The object of the present invention is in particular to resolve this problem.

### SUMMARY OF THE INVENTION

In this context, more precisely, the invention relates according to a first of its subjects to a wired drone (100) for treating a surface (200) by spraying a treatment fluid, the drone (100) comprising:
a propulsion system comprising a set of motors, front rotors and rear rotors,
a system for projecting the treatment fluid, comprising a set of at least one spray nozzle for spraying said treatment fluid, preferably at high pressure, said set comprising a solenoid valve and being connected to a leaktight conduit for the treatment fluid supply,
a set of at least one distance sensor.

The set of at least one distance sensor comprises:
a first sonar (110), which is configured to measure the distance between said first sonar (110) and said surface (200),
a second sonar (120), which is preferably identical to the first sonar (110), is oriented in the same direction as the first sonar (110) and is configured to measure the distance between said second sonar (120) and said surface (200),
the drone (100) furthermore comprising:
a calculation unit, which is configured to:
measure the distance between said first sonar (110) and said surface (200);
measure the distance between said second sonar (120) and said surface (200);
calculate a differential measurement between the measurement of the first sonar (110) and the measurement of the second sonar (120);
to deduce therefrom:
the yaw angle of the drone (100) with respect to a normal to the surface (200), and
the distance from the drone (100) to the surface (200);
and to slave the position of the drone (100) with respect to the surface (200) by the difference between:
the calculated distance and a predetermined calculated distance, and
the calculated yaw angle of the drone (100) and a predetermined yaw angle setpoint of the drone (100).

It is essentially characterized in that:
the drone (100) comprises an autopilot system comprising a general slaving device, which comprises a first PID controller and which allows slaving in roll, yaw and pitch, and in which the calculation unit, which comprises a second PID controller different to the first PID controller, is configured to slave the position of the drone (100) with respect to the surface (200) by the difference between:
   the calculated distance and a predetermined distance setpoint, and
   the calculated yaw angle of the drone (100) and a yaw angle setpoint of the drone (100).

By virtue of the invention, the spraying of the treatment fluid may be carried out at a constant flow rate.

Maintaining the drone at a setpoint distance coupled with a predetermined yaw angle allows effectiveness of the spraying to be ensured when the drone flies in vertical passes.

The calculation unit may be configured to slave the position of the drone (100) with respect to said surface (200) so that the difference between the calculated yaw angle of the drone (100) and the yaw angle setpoint is equal to 0.

By virtue of this feature, the spraying of the treatment fluid is more effective, in particular with spray nozzles which project in a cone or in a triangle.

The first sonar (110) and second sonar (120) may be symmetrical to one another with respect to a longitudinal plane of symmetry.

By virtue of this feature, the calculations for maintaining position are simpler.

The activation of the system for projecting the treatment fluid may be slaved to the position of the drone (100) with respect to the surface (200).

By virtue of this feature, the spraying may start only when the drone is in an effective position, which saves on the consumption of the treatment fluid.

The set of at least one distance sensor may furthermore comprise at least one of the following sensors:
a set of at least one third sonar;
a set of at least one stereo camera, the detection distance of which is greater than the detection distance of the first sonar (110), of the second sonar (120) or of the third sonar.

The set of at least one distance sensor may furthermore comprise at least one lidar (360), the detection distance of which is greater than the detection distance of the stereo camera.

By virtue of this feature, the position of the drone is known precisely since each sensor is activated as a function of the determined distance to the surface and the range of said sensor.

Furthermore, by virtue of the stereo camera or the lidar, it is possible to generate a cloud of points from which a plane, and therefore a distance to the plane and a normal to the plane, can be extracted by using known algorithms, which are sometimes integrated particularly into certain stereo cameras.

Automatic pilot means may furthermore be provided, so that the drone (100) is autonomous or semiautonomous.

The drone (100) may comprise an autopilot system comprising a general device for slaving the drone (100) in roll, yaw and pitch, and in which the calculation unit, which comprises a PID controller different to the general device for slaving the drone (100) in roll, yaw and pitch, is configured to slave the position of the drone (100) with respect to the surface (200) by the difference between:
the calculated distance and a predetermined distance setpoint, and
the calculated yaw angle of the drone (100) and a yaw angle setpoint of the drone (100).

By virtue of this feature, a standard drone may be adapted in order to carry out the invention.

The accuracy in the position of the drone (100) with respect to said surface (200) may be 5 cm +/−10% over a position range of the set of at least one spray nozzle lying between 5 cm and 90 cm from said surface (200).

By virtue of this feature, carrying out the treatment of the surface with a drone according to the invention is particularly effective.

According to another of its subjects, the invention relates to a method for treating a surface (200) with a treatment fluid by using a wired drone (100) according to the invention, the method comprising steps consisting in:
detecting the distance from the drone (100) to said surface (200),
detecting the yaw angle of the drone (100) with respect to a normal to the surface (200),
slaving the position of the drone (100) with respect to the surface (200) by the difference between:
the detected distance and a predetermined distance setpoint, and
the detected yaw angle of the drone (100) and a predetermined yaw angle setpoint of the drone (100),
the method furthermore comprising at least one of the steps consisting in:
producing a depth map by using the measurements of the set of at least one distance sensor,
detecting defects on said surface (200) by using the measurements of the set of at least one distance sensor, and
spraying a treatment fluid, preferably at high pressure, onto said surface (200).

In the context of the present invention, the following verbs are used without distinction: detect, measure and determine.

Advantageously, the present invention employs only a single drone rather than a swarm of drones.

The drone according to the invention may advantageously be used in constrained urban areas, including residential areas, and at a few centimeters from the frontages, in the fields of building, construction or renovation. It may also be used in the audiovisual field, industry, agriculture, etc.

Other features and advantages of the present invention will become clearer on reading the following description, which is given by way of illustration and without limitation, and is provided with reference to the appended figures.

### BRIEF DESCRIPTION OF THE DRAWINGS

FIG. 1 illustrates the local frame of reference of a drone according to the invention,

FIG. 2 illustrates a plan view of a drone according to the invention,

FIG. 3 illustrates a plan view of a drone according to the invention, which has a certain yaw,

FIG. 4 illustrates the drone of FIG. 3 in a profile view.

### DETAILED DESCRIPTION

The solution according to the invention comprises a drone 100. The drone 100 comprises a propulsion system known per se, which comprises a set of motors, front rotors and rear rotors, and which will not be described in further detail.

The drone 100 also comprises a system for projecting the treatment fluid, also known per se, for example of the application FR3125017 filed by the Applicant. The system for projecting the treatment fluid comprises a set of at least one spray nozzle for spraying said treatment fluid, preferably at high pressure (100-130 bar), said set comprising a solenoid valve and being connected to a leaktight conduit for the treatment fluid supply.

The drone 100 also comprises a calculation unit, which is described below.

Preferably, the drone 100 comprises automatic pilot means so that the drone 100 is autonomous or semiautonomous.

For example, the drone 100 is of the rotorcraft type (generally a quadcopter or octocopter) and during flight should remain at a predetermined fixed distance from a surface 200 to be treated.

For brevity, the surface 200 to be treated is referred to as “the surface”.

The surface 200 may be plane or curved and is vertical overall, that is to say it may be strictly vertical or have an inclined slope, or alternatively a polygonal structure.

If the drone 100 moves closer or further away with respect to the predetermined distance to the surface 200, whether because of the inaccuracy of its inertial measurement unit (IMU) or its satellite positioning system (GNSS), or because of an external perturbation (wind), it is essential for it to be repositioned automatically at the predetermined distance without oscillations, relatively rapidly and while avoiding a collision with the surface 200.

This holding at a predetermined distance assists in better management of the problems involved with the treatment of a surface 200, in particular by high-pressure spraying.

Specifically, depending on the nozzles and the pressure employed, beyond a threshold distance, for example at more than 10 cm from the surface 200, a high-pressure jet may no longer achieve cleaning; at less than 3 cm, there is a risk of stripping the coating from the surface 200 (for example roughcast).

The spraying, in particular at high pressure, generates a spray mist or fog, which is commensurately greater in proximity to the surface 200 because the droplets are partly reflected by the surface 200. This spray mist interferes with a camera or a lidar, and may interfere with the magnetic compass of a drone 100, even if only water is sometimes sprayed.

Furthermore, in the case of spraying maintenance products, the maintenance products which are sprayed may have a certain viscosity and may tend to adhere to the sensors.

The present invention makes it possible to overcome this problem in a constrained outdoor environment, in particular by using sonars which for their part are not interfered with by the spray mist.

The environment in which the drone 100 operates is referred to as “constrained” because of the actual structure of the surface 200 to be treated or of the surrounding surfaces, which may mask the GPS signal or interfere with the Earth's magnetic field, for example because of metal structures, or alternatively because of movements of the wind turbine blades, etc. The structure of the surface 200 may be complex due to the actual architecture of a building, which comprises for example balconies, windows, antennas, foliage, etc., as well as frontages which have inclined slopes. It is therefore continuously necessary to compensate for the variation in the distance to the surface 200 so that the distance to the frontage is substantially constant, while being slaved by means of sensors as described below.

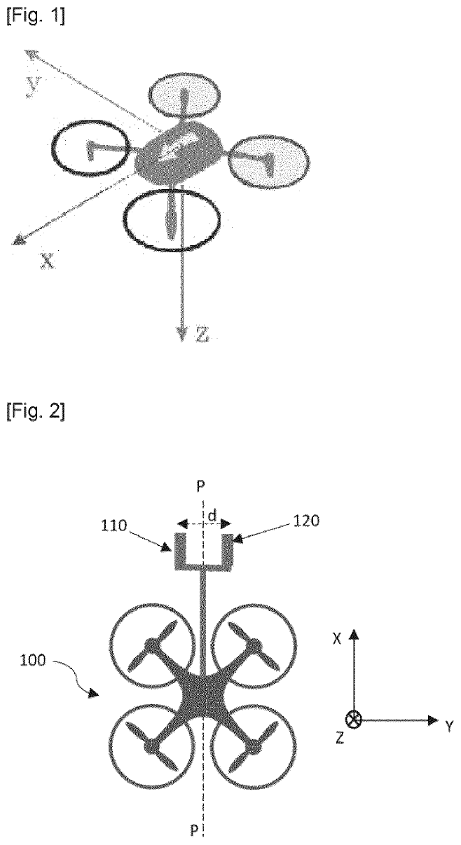

The drone 100 has a local frame of reference, which is illustrated in FIG. 1.
the X axis is the roll axis, i.e. the axis of left/right displacement;
the Y axis is the pitch axis, i.e. the axis of front/rear displacement; and
the Z axis is the yaw axis, i.e. the axis of vertical rotation.

In the case in point, the drone 100 is intended to remain at a predetermined fixed X distance and its X axis is intended to be perpendicular to the surface 200, assuming the surface 200 to be locally plane.

The drone 100 therefore needs to be constrained in pitch and in yaw:
in pitch for ensuring a fixed distance to the surface 200.
in yaw for ensuring perpendicularity to the surface 200.

The “yaw angle” refers to the angle between the vector of the X axis of the drone (the heading of the drone) and a vector normal to the surface 200.

The “yaw control” refers to an angular velocity control for rotating the drone about its yaw axis.

The distance from the drone 100 to the surface 200 may be estimated by a distance sensor. If the drone 100 is not perpendicular to the surface 200, however, that is to say if the X axis is not parallel to the normal to the surface 200, the measurement of the distance will be incorrect.

Advantageously, according to the invention, a set of at least two distance sensors is preferably employed.

According to the invention, the set of at least two distance sensors comprises a first sonar 110 and a second sonar 120, which is preferably identical to the first sonar 110.

Sonars are advantageous because their measurements are more accurate than those of a camera; in contrast to lidars, reflecting surfaces such as reflective or transparent windows do not interfere with the measurements of a sonar.

In the case in point, the distance sensors are front sensors arranged beyond the blades.

Preferably, the first sonar 110 and the second sonar 120 are symmetrical to one another with respect to a longitudinal plane of symmetry P, as illustrated in FIG. 2.

The first sonar 110 is configured to measure the distance between said first sonar 110 and said surface 200.

The second sonar 120 is preferably oriented in the same direction as the first sonar 110 and configured to measure the distance between said second sonar 120 and said surface 200.

By using the measurements of the first sonar 110 and of the second sonar 120, the calculation unit can determine the distance between said first sonar 110 and the surface 200 and the distance between said second sonar 120 and the surface 200.

If the second sonar 120 is identical to the first sonar 110 and the drone 100 is perpendicular to the surface 200, the measurements of the first sonar 110 and of the second sonar 120 will be the same.

By calculating a differential measurement between the measurement of the first sonar and the measurement of the second sonar 120, the calculation unit is capable of determining:
on the one hand the yaw angle of the drone 100, and
on the other hand the distance from the drone 100 to the surface 200.

With D1 being the value of the distance from the first sonar 110 to the surface 200 and D2 being the value of the distance from the second sonar 120 to the surface 200:
the yaw angle of the drone 100 with respect to a normal to the surface 200 can be calculated. It is specifically the angle of the surface normal with respect to the X axis of the drone. In practice, a yaw angular velocity setpoint is obtained after the PID loop described below by using the difference between the two distances from the first sonar and from the second sonar;
the distance from the drone 100 to the surface 200 may be estimated by the smaller of these two distance values D1 and D2, i.e. min(D1, D2), or by trigonometric calculation since the distance between the first sonar 110 and the second sonar 120 is known.

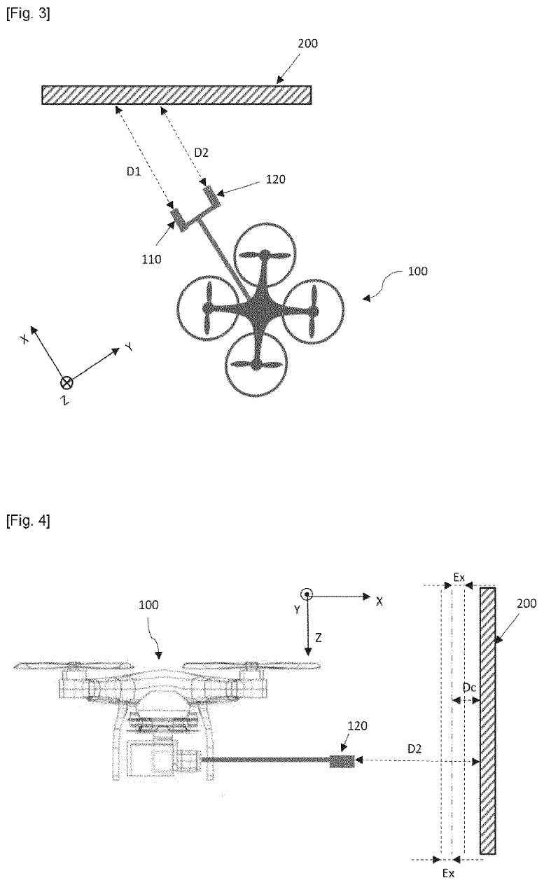

Without calculating the value of the yaw angle, whether the drone 100 is perpendicular to the surface 200 may be determined easily by a simple difference α=D1−D2, as illustrated in FIG. 3. If this value a is zero, the two sonars are at the same distance from the surface and the drone 100 is locally perpendicular to the surface 200. If the error a is negative, the drone 100 is pointing too far to the left, and vice versa when the error a is positive.

For the flight, the drone 100 receives:
a predetermined yaw angle setpoint of the drone 100, typically with a value equal to 0; and
a predetermined distance setpoint Dc to the surface 200.

Preferably, a tolerance Ex is provided in the X positioning around the distance setpoint Dc to the surface 200, preferably with Ex=<Dc; referring to FIG. 4.

The distance D from the drone 100 to the surface 200 is estimated by a value D=min(D2, D1).

In order to slave the X distance of the drone 100, the value δ=D−Dc=min(D2, D1) Dc may be calculated. If the value o is positive, this indicates that the drone 100 is too far from the surface 200; if the value o is negative, this indicates that the drone 100 is too close. In the case in point, a PID controller is provided, which employs a PID loop for slaving the drone 100 in pitch and in yaw to the surface 200. Preferably, in order to avoid control overloads, the pitch slaving is carried out before the yaw slaving.

Typically, a standard drone comprises an autopilot system comprising a general slaving device (in roll, yaw and pitch) which comprises a first PID controller which is known per se and is supplied with most standard drones. This first PID controller allows auto-stabilization of the flight, but without reference to a frontage or GPS.

According to the invention, a second PID controller is provided. The second PID controller of the invention is different to this first PID controller, and additional to it. A drone according to the invention therefore comprises 2 PID controllers: a standard PID controller for the flight stabilization and a PID controller according to the invention, which allows slaving in pitch and in yaw with respect to the normal to a surface.

The second PID controller according to the invention allows the drone to be controlled based on the calculation of an error or on a measurement. Two values may be calculated, which can be positive or negative, depending on the orientation of the drone, and which should tend toward 0 because of the PID control system.

1. The first measurement is directly the yaw angle.

According to the definition of the yaw angle, if it is equal to zero, the first sonar and the second sonar are aligned and the drone is therefore perpendicular to the surface 200, and in a good situation for treating the surface 200. If the yaw angle is negative or positive, an angular velocity setpoint is provided in order to pivot the drone about the Z axis in the positive sense or negative sense;

With D1 and D2 being the distances estimated by the first sonar and the second sonar, respectively, and d being the distance between the two sonars (see FIG. 2), the yaw angle A is given by the following trigonometric calculation: A=arctan((D2−D1)/d).

2. The second measurement, which is a differential measurement, is the difference between the distances measured by the first sonar 110 and by the second sonar 120. This difference is a good substitution function for estimating the “status” of the drone. Just as for the exact calculation of the yaw angle, if this difference is equal to zero, the drone is positioned suitably with respect to the surface 200. A positive or negative difference leads to an appropriate setpoint for repositioning the drone. The distance difference is given quite simply by D2−D1.

A set of at least one third sonar may also be provided.

In the case in point, a set of four sonars may be provided, in which the first sonar 110 and the second sonar 120 are identical and have identical detection cones. The first sonar 110 and the second sonar 120 make it possible to determine not only the distance between the drone 100 and the surface 200 but also the angle between the drone 100 and the surface 200, that is to say the yaw, by using the differential calculation.

A third sonar, the detection range of which is greater than that of the first sonar 110 and of the second sonar 120, makes it possible to detect whether the drone 100 is at a long distance from the surface 200, that is to say beyond a determined threshold value.

A fourth sonar, the detection range of which is less than that of the first sonar 110 and of the second sonar 120, makes it possible to detect whether the drone 100 is at a short distance from the surface 200, that is to say within a predetermined threshold value; this makes it possible to carry out emergency detection if the drone 100 is too close to the surface 200, that is to say the distance between the drone 100 and the surface 200 presents a danger.

A set of at least one stereo camera may also be provided, the detection distance of which is greater than the detection distance of the first sonar 110, of the second sonar 120 or of the third sonar.

At least one lidar 360 may furthermore also be provided, the detection distance of which is greater than the detection distance of the stereo camera.

A succession of detection distance ranges may thus be obtained, one range per type of sensor.

During operation, in one embodiment, so long as the sonars are not returning a value (the sonars have a detection capacity of the order of one meter), the position of the drone 100, or more precisely the distance between the drone 100 and the surface 200, is determined by the minimum of the values of the other sensors (lidar and stereo camera). As soon as the sonars become active, the values of the sonars replace those of the other sensors (lidar and stereo camera), in which case the values of the lidar and stereo camera may be ignored.

At a distance of 1 m, the first sonar and the second sonar 120 take over from the stereo camera because they are more accurate and less susceptible to noise.

With four sonars, operation will advantageously involve 2 pairs of sonars:
a first sonar pair comprising the first sonar and the second sonar 120, in which the sensors are identical to one another and which makes it possible to manage the yaw of the drone 100 with respect to the surface 200, which is assumed to be locally plane; and
a second sonar pair comprising the third sonar and the fourth sonar, in which the sensors are different to one another and which makes it possible to manage the distance to the surface 200 so that the drone 100 is “neither too close nor too far”, i.e. in a predetermined distance range.

The distance from each (sonar) sensor to the surface 200 is determined by the value of each sensor, in particular of the sonars. The distance D from the drone 100 to the surface 200 is thus determined.

Likewise, by a differential calculation of the measurements of the first sonar 110 and of the second sonar 120, it is possible to detect the yaw angle of the drone 100 with respect to a normal to the surface 200.

It is then possible to slave the position of the drone 100 with respect to the surface 200, in particular the distance, that is to say the X position, by a predetermined distance setpoint. It is also possible to slave the position of the drone 100 with respect to the surface 200 by the yaw angle of the drone 100, which is detected by using the measurements of the first sonar 110 and of the second sonar 120, with reference to a predetermined yaw angle setpoint of the drone 100.

Regardless of the nature of the distance sensors, a depth map may advantageously furthermore be produced by using the measurements of the set of at least one distance sensor, in particular a stereo camera.

Advantageously, according to the invention, defects on the surface 200 may be detected by using the measurements of the set of at least one distance sensor, in particular by using the sonars and more particularly by using the fourth sonar.

The stereo camera may work simultaneously with the sonars. Preferably, the values of the sonars take precedence over those of the stereo camera because the values measured by the sonars have a variance lower than that of the values of the stereo camera.

Typically, the stereo camera is reliable as far as a distance of 3 m from the surface 200. The stereo camera is therefore optional.

Thus, the environment in which the drone 100 operates may be segmented as a function of 3 distance sensors:
the sonars, which make it possible to manage the environment close to the surface 200;
the stereo camera for an environment at 4 m from the surface 200, with an angle wider than that of the sonars;
a lidar 360 for even wider acquisition of the environment, beyond 4 m, or for a complex surface 200 or frontage (for example a balcony).

Advantageously, according to the invention, it is not necessary to carry out mapping before the flight.

Quite clearly, a treatment fluid may be sprayed, preferably at high pressure, onto said surface 200.

The activation of the system for projecting the treatment fluid is preferably slaved to the position of the drone 100 with respect to the surface 200. Preferably, the system for projecting the treatment fluid is activated only when the distance D from the drone 100 to the surface 200 is equal to the distance setpoint.

For example, in the case of high-pressure cleaning, the high-pressure cleaning nozzle is at approximately 5 cm from the surface 200 to be cleaned and the body of the drone 100 is at approximately 1 m from it.

In order to spray maintenance products, the spray nozzle is for example at approximately 40 cm from the surface 200 to be maintained. By virtue of the invention, the accuracy in the position is approximately 5 cm over a position range of the nozzle lying between 5 cm and 90 cm from the surface 200.

“Approximately” is intended to mean with a margin of plus or minus 10%.

1. A wired drone (100) for treating a surface (200) by spraying a treatment fluid, the drone (100) comprising:
a propulsion system comprising a set of motors, front rotors and rear rotors,
a system for projecting the treatment fluid, comprising a set of at least one spray nozzle for spraying said treatment fluid, preferably at high pressure, said set comprising a solenoid valve and being connected to a leaktight conduit for the treatment fluid supply,
a set of at least one distance sensor,
wherein the set of at least one distance sensor comprises:
a first sonar (110), which is configured to measure the distance between said first sonar (110) and said surface (200),
a second sonar (120), which is preferably identical to the first sonar (110), is oriented in the same direction as the first sonar (110) and is configured to measure the distance between said second sonar (120) and said surface (200),
the drone (100) furthermore comprising:
a calculation unit, which is configured to:
measure the distance between said first sonar (110) and said surface (200);
measure the distance between said second sonar (120) and said surface (200);
calculate a differential measurement between the measurement of the first sonar (110) and the measurement of the second sonar (120);
to deduce therefrom:
the yaw angle of the drone (100) with respect to a normal to the surface (200), and
the distance from the drone (100) to the surface (200);
and to slave the position of the drone (100) with respect to the surface (200) by the difference between:
the calculated distance and a predetermined distance setpoint, and
the calculated yaw angle of the drone (100) and a predetermined yaw angle setpoint of the drone (100);
characterized in that
the drone (100) comprises an autopilot system comprising a general slaving device, which comprises a first PID controller and which allows slaving in roll, yaw and pitch, and in which the calculation unit, which comprises a second PID controller different to the first PID controller, is configured to slave the position of the drone (100) with respect to the surface (200) by the difference between:
the calculated distance and a predetermined distance setpoint, and
the calculated yaw angle of the drone (100) and a yaw angle setpoint of the drone (100).

2. The drone (100) as claimed in claim 1, wherein the calculation unit is configured to slave the position of the drone (100) with respect to said surface (200) so that the difference between the calculated yaw angle of the drone (100) and the yaw angle setpoint is equal to 0.

3. The drone (100) as claimed in any one of the preceding claims, wherein the first sonar (110) and second sonar (120) are symmetrical to one another with respect to a longitudinal plane of symmetry.

4. The drone (100) as claimed in any one of the preceding claims, wherein the activation of the system for projecting the treatment fluid is slaved to the position of the drone (100) with respect to the surface (200).

5. The drone (100) as claimed in any one of the preceding claims, wherein the set of at least one distance sensor furthermore comprises at least one of the following sensors:
a set of at least one third sonar;
a set of at least one stereo camera, the detection distance of which is greater than the detection distance of the first sonar (110), of the second sonar (120) or of the third sonar.

6. The drone (100) as claimed in claim 5, wherein the set of at least one distance sensor furthermore comprises at least one lidar (360), the detection distance of which is greater than the detection distance of the stereo camera.

7. The drone (100) as claimed in any one of the preceding claims, furthermore comprising automatic pilot means so that the drone (100) is autonomous or semiautonomous.

8. The drone (100) as claimed in any one of the preceding claims, wherein the accuracy in the position of the drone (100) with respect to said surface (200) is 5 cm +/−10% over a position range of the set of at least one spray nozzle lying between 5 cm and 90 cm from said surface (200).

9. A method for treating a surface (200) with a treatment fluid by using a wired drone (100) as claimed in any one of the preceding claims, the method comprising steps consisting in:
detecting the distance from the drone (100) to said surface (200),
detecting the yaw angle of the drone (100) with respect to a normal to the surface (200),
slaving the position of the drone (100) with respect to the surface (200) by the difference between:
the detected distance and a predetermined distance setpoint, and
the detected yaw angle of the drone (100) and a predetermined yaw angle setpoint of the drone (100),
the method furthermore comprising at least one of the steps consisting in:
producing a depth map by using the measurements of the set of at least one distance sensor,
detecting defects on said surface (200) by using the measurements of the set of at least one distance sensor, and
spraying a treatment fluid, preferably at high pressure, onto said surface (200).
